(19) United States
(12) Patent Application Publication
(10) Pub. No.: US 2026/0342228 A1
(43) Pub. Date: Oct. 29, 2026

(54) LOW POWER TELEMETRY FOR BUCK CONVERTERS

(71) Applicant: Apple Inc., Cupertino, CA (US)

(72) Inventors: Narendra S Mehta, San Carlos, CA (US); Francesco Griseta, Livorno (IT); Tommaso Baldetti, Pisa (IT); Pietro Gabriele Gambetta, Livorno (IT); Giovanni Gabrielli, Pisa (IT)

(21) Appl. No.: 19/189,347

(22) Filed: Apr. 25, 2025

(51) Int. Cl. H02M 3/158

(52) U.S. Cl. CPC H02M 3/158

(57) ABSTRACT

A buck converter can include an input that receives a DC input voltage; a plurality of switching devices coupled across the input and switched complementarily, the plurality of switching devices having a switch node associated therewith; an inductor having a first terminal coupled to the switch node associated with the plurality of switching devices and a second terminal coupled to an output of the buck converter that delivers a DC output voltage that is less than the DC input voltage; and control circuitry that generates drive signals for the plurality of switching devices to regulate the output voltage; and determines an output current of the buck converter by determining a ripple current contribution to the output current, determining a valley current contribution to the output current, and combining the ripple current contribution with the valley current contribution.

### BACKGROUND

Buck converters are widely used in various power supply and voltage regulation applications, such as those related to personal electronic devices. In some cases, such devices may be battery powered and may have relatively small batteries. Thus, it can be desirable to improve operating efficiency of such buck converters, such as by reducing power demand associated with the control and monitoring circuitry of such buck converters.

### SUMMARY

A buck converter can include an input that receives a DC input voltage; a plurality of switching devices coupled across the input and switched complementarily, the plurality of switching devices having a switch node associated therewith; an inductor having a first terminal coupled to the switch node associated with the plurality of switching devices and a second terminal coupled to an output of the buck converter that delivers a DC output voltage that is less than the DC input voltage; and control circuitry that generates drive signals for the plurality of switching devices to regulate the output voltage; and determines an output current of the buck converter by determining a ripple current contribution to the output current, determining a valley current contribution to the output current, and combining the ripple current contribution with the valley current contribution.

The buck converter can be a three-level buck converter. The plurality of switching devices can include a switch ladder of four switching devices including an outer pair switched complementarily to each other and an inner pair switched complementarily to each other and 180 degrees out of phase with respect to the outer pair. The buck converter can further include a flying capacitor coupled across the inner switch pair.

The control circuitry can determine the ripple current contribution at least in part by using a pulse counter to count pulse frequency modulation pulses corresponding to switching cycles of the plurality of switching devices. The control circuitry can determine the valley current contribution with reference to a current demand signal determined by comparing an output voltage feedback signal of the buck converter to a reference voltage. The current demand signal can be a scaled current demand signal. The current demand signal can be trimmed to provide a desired offset and scale. The offset can be provided by an adjustable current source, and the scale can be provided by a variable resistor.

A buck converter control circuit can include duty cycle control circuitry that generates drive signals for a plurality of switching devices of the buck converter to regulate an output voltage of the buck converter by comparing an output voltage of the buck converter to a reference voltage; and output current determination circuitry that determines an output current of the buck converter by determining a ripple current contribution to the output current; determining a valley current contribution to the output current; and combining the ripple current contribution with the valley current contribution.

The control circuit can determine the ripple current contribution at least in part by using a pulse counter to count pulse frequency modulation pulses corresponding to switching cycles of the plurality of switching devices. The control circuitry can determine the valley current contribution with reference to a current demand signal determined by comparing an output voltage feedback signal of the buck converter to a reference voltage. The current demand signal can be a scaled current demand signal. The current demand signal can be trimmed to provide a desired offset and scale. The offset can be provided by an adjustable current source, and the scale can be provided by a variable resistor.

A method of determining an output current of the buck converter, performed by control circuitry of a buck converter, can include determining a ripple current contribution to the output current; determining a valley current contribution to the output current; and combining the ripple current contribution with the valley current contribution.

Determining the ripple current contribution can include using a pulse counter to count pulse frequency modulation pulses corresponding to switching cycles of a plurality of switching devices of the buck converter. Determining the valley current contribution can include reference to a current demand signal determined by comparing an output voltage feedback signal of the buck converter to a reference voltage. The current demand signal can be a scaled current demand signal. The current demand signal can be trimmed to provide a desired offset and scale. The offset can be provided by an adjustable current source, and the scale can be provided by a variable resistor.

### BRIEF DESCRIPTION OF THE DRAWINGS

FIG. 1 illustrates a simplified schematic diagram of a buck converter.

FIG. 2 illustrates a simplified schematic diagram of a three-level buck converter.

FIG. 3 illustrates a plot of buck converter current for various operating conditions.

FIG. 4 illustrates a simplified schematic diagram of a low power telemetry system for buck converters.

FIG. 5 illustrates a simplified schematic diagram of a low power telemetry system for buck converters.

FIG. 6 illustrates a flowchart of a low power telemetry system for buck converters.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

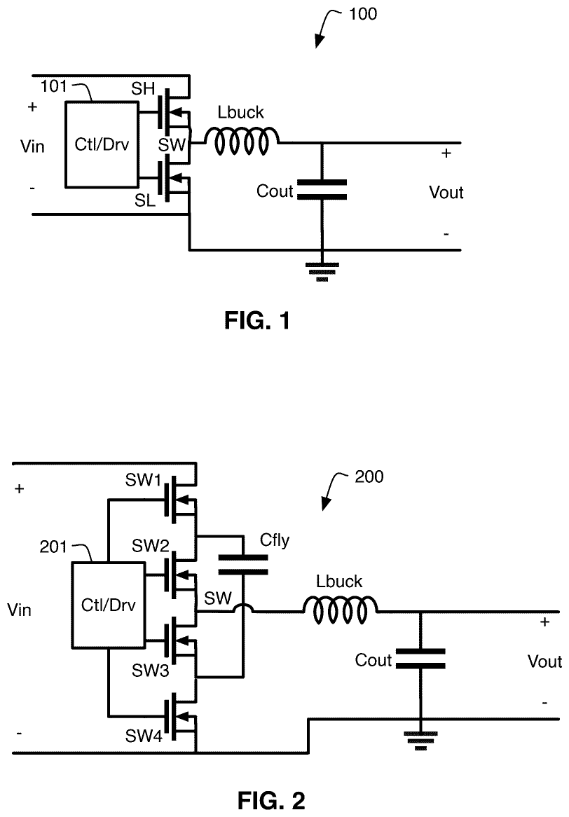

FIG. 1 illustrates a simplified schematic diagram of a buck converter 100. Buck converter receives a DC input voltage Vin and produces a DC output voltage V out that is less than the input voltage. This operation can be achieved by complementary operation of switching devices, such as a high side switch SH and a low side switch SL to modulate the current through an inductor L buck. Complementary operation means that when high side switch SH is turned on, low side switch SL is turned off and vice-versa. There may be some small dead time between turn off of one switch and turn on of its complement to prevent cross-conduction that would short circuit the input. In any case, this complementary switching operation selectively: (1) supplies current to inductor L buck and a load connected to the output from the input voltage (thereby storing energy in inductor L buck) or (2) supplies the load from energy stored in buck inductor L buck via a circulating current through the low side switch (thereby discharging energy stored in buck inductor L buck). Viewed another way, the voltage at switch node SW alternates between Vin and 0. An output capacitor Cout can filter out the ripple current associated with the switching operation.

Switches SH and SL are illustrated as MOSFET switching devices, but other types of switching devices (such as other transistor types) could alternatively be used. Additionally, other semiconductor devices, such as thyristors, SCRs, etc. could be used. In some buck converters, the low side switch SL may be implemented a diode, although synchronous rectification (as illustrated) may provide for improved operating efficiency. Semiconductor switching devices can be implemented using any suitable semiconductor material, such as silicon, silicon carbide (SIC), gallium nitride (GaN), etc.

Control/driver circuitry 101 can monitor the output voltage V out via a feedback signal (not shown) and produce drive signals for the high side switch SH and low side switch SL. In general, the duty cycle of high side switch SH will increase with increased load at the output of the three-level buck converter. The control/driver circuitry may be implemented in a variety of forms, including any suitable combination of analog circuitry (such as error amplifiers, resistors, capacitors, etc.), digital circuitry (such as logic gates, flip-flops, etc.) and/or programmable circuitry (such as microcontrollers, microprocessors, etc.). These circuits can be made up of discrete components, integrated circuits, or various combinations thereof. In some embodiments, the power switches, i.e, high side switch SH and low side switch SL can be integrated into the same package and/or same integrated circuit die as the control/driver circuitry. As described in greater detail below, monitoring the output current (i.e., the current through inductor L buck) can be desirable for various control strategies of the buck converter. Otherwise, construction and operation of such converters is known to those skilled in the art, and thus further details of such circuits are not repeated here.

FIG. 2 illustrates a simplified schematic diagram of a three-level buck converter 200. The three-level buck converter combines a flying capacitor converter and a buck converter to provide for improved operating efficiency and other advantages in certain regimes. Like the buck converter, the three-level buck converter converts a DC input voltage Vin to a DC output voltage V out that is lower than Vin. This is accomplished by operation of a switch ladder made up of four switches SW1-SW4 in the illustrated example. Outer switches SW1 and SW4 can be operated generally as described above with respect to FIG. 1 and high side switch SH and low side switch SL. That is, switches SW1 and SW4 can be switched complementarily with a duty cycle D that is directly related to the load on the converter. Inner switches SW2 and SW3 can be operated complementarily to each other (that is, when switch SW2 is off, switch SW3 is on, and vice-versa) and 180 degrees out of phase with respect to outer switches SW1 and SW4. That is, switch SW2 is operated at the same frequency and duty cycle as switch SW1, but 180 degrees out of phase, and switch SW3 is operated at the same frequency and duty cycle as switch SW4, but 180 degrees out of phase.

This effectively results in a switched flying capacitor converter, made up of switches SW1-SW4 and flying capacitor Cfly, supplying a voltage at the switch node SW that alternates among the input voltage V in, the flying capacitor voltage (which averages ½ the input voltage, i.e, Vin/2), or 0 volts. These three voltage levels are where the three-level buck converter gets its name, and the buck converter of FIG. 1 may thus also be considered as a two-level buck converter. Buck inductor L buck is connected between the switch node and the output, as in the buck converter of FIG. 1. Likewise, an output capacitor Cout can be provided, essentially as described above with respect to FIG. 1.

Switches SW1-SW4 are illustrated as MOSFET switching devices, but as described above, other types of switching devices of any suitable semiconductor material could also be used.

Control/driver circuitry 201 can monitor the output voltage V out via a feedback signal (not shown) and produce drive signals for the switches SW1-SW4. In general, the duty cycle of switch SW1 will increase with increased load at the output of the three-level buck converter. The control/driver circuitry may be implemented in a variety of forms, including any suitable combination of analog circuitry (such as error amplifiers, resistors, capacitors, etc.), digital circuitry (such as logic gates, flip-flops, etc.) and/or programmable circuitry (such as microcontrollers, microprocessors, etc.). These circuits can be made up of discrete components, integrated circuits, or various combinations thereof. In some embodiments, the power switches, i.e, switches SW1-SW4 can be integrated into the same package and/or same integrated circuit die as the control/driver circuitry. As described in greater detail below, monitoring the output current (i.e, the current through buck inductor L buck) can be desirable for various control strategies of the three-level buck converter. Otherwise, construction and operation of three-level buck converters is known to those skilled in the art, and thus further details of such circuits are not repeated here.

For purposes of the present application, a buck converter can be understood as including either a “regular” buck converter, as illustrated and described with respect to FIG. 1, or a three-level buck converter, as illustrated and described with respect to FIG. 2. Additionally, buck converter can be understood as including further multi-level buck converters, such as four or more level buck converters, which can incorporate further switch pairs in the switch ladder and additional flying capacitors to provide additional voltages at the switch node. Such converters are known to those skilled in the art, and thus details of their construction and operation are not repeated herein.

A buck converter can be considered as operating in one of two modes, depending on the inductor current. If the inductor current reaches and remains at zero for some period of time between successive switching cycles, the buck converter can be said to operate in a discontinuous conduction mode (DCM). If the inductor current always remains positive between and through successive switching cycles, the buck converter can be said to operate in a continuous conduction mode (CCM). A third mode, critical conduction mode, corresponds to the condition in which the inductor current reaches zero right at the beginning of the next switching cycle, and thus does not remain at zero. However, for purposes of current monitoring as in the present application, this mode can be thought of as equivalent to DCM operation.

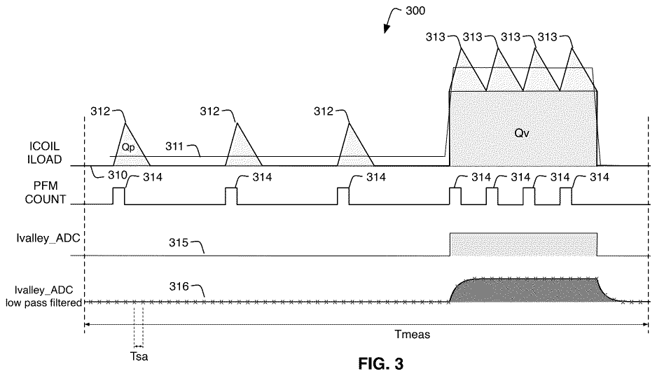

FIG. 3 illustrates a plot 300 illustrating buck converter current for DCM and CCM operating conditions. Curve 310 depicts the coil current ICOIL, i.e., the current flowing through the buck inductor L buck. Curve 311 illustrates the load current ILOAD. The instantaneous difference between the coil current and the load current is made up by the output capacitor Cout. More specifically, output capacitor Cout stores energy by charging with any excess of the instantaneous coil current above the load current and discharges by making up any difference between the load current and the coil current when the coil current is less than the load current.

The left-hand portion of FIG. 3 corresponds to a DCM operation, in which a series of inductor current pulses 312 correspond to the switching cycles. More specifically, when the high side switch QH is turned on, the coil current ramps up linearly, and when high side switch QH is turned off and low side switch QL is turned on, the coil current ramps back down to zero. Between switching cycles, the coil current remains at zero, and the load current is supplied by the output capacitor Cout, as described above. Each of the current pulses corresponds to a pulse frequency modulation (PFM) pulse 314 generated by the control circuitry to trigger a switching cycle so as to maintain a regulated output voltage V out. In general, DCM operation can be used to improve operating efficiency during light load conditions. The area under the curve of each pulse (Qp) can correspond to an amount of charge (or energy) delivered to the load during each pulse.

The right-hand portion of FIG. 3 corresponds to a CCM operation, in which a series of inductor current pulses 313 correspond to the switching cycles. However, the coil current never decreases all the way to zero, e.g., because of higher load conditions. More specifically, when the high side switch QH is turned on, the coil current ramps up linearly, and when high side switch QH is turned off and low side switch QL is turned on, the coil current ramps back down, but not reaching zero before low side switch QL turns off and high side switch QH again turns on. As in DCM each of the current pulses in CCM also corresponds to a PFM pulse 314 generated by the control circuitry to trigger a switching cycle so as to maintain a regulated output voltage V out. In general, CCM operation can correspond to higher load (as opposed to light load) conditions. The area under the curve can correspond to an amount of charge (or energy) delivered to the load, with an overall area Qv corresponding to the “base load” or current valley/minimum value, and the individual peaks Qp corresponding to each respective switching cycle.

In many buck converter applications, it may be desirable to know the coil current with a sufficiently high level of accuracy to achieve the desired control effects or objectives implemented by the control circuitry. Previously, such applications have employed various forms of fast current sensing techniques, often employing additional current sensing circuitry, such as series current sensing resistors, current shunts, Hall effect sensors, etc. For low power converters, including but not limited to converters used in battery-operated devices including battery-operated devices with relatively small batteries and/or small devices, such sensing techniques may be less desirable. For example, the additional components and circuitry required for direct current sensing can increase cost and size of the implementation, as well as introducing undesirable additional power consumption. The inventors of the present application have discovered a technique for performing coil current measurements of sufficient accuracy based on parameters used by the control circuitry, thereby eliminating the need for additional components that would provide for undesired increase in component count, solution size, energy consumption, operating efficiency, and costs.

More specifically, the coil current can be sensed by separating the coil current contribution from the individual switching pulses (e.g., Qp, as described above) and the contribution of the non-zero valley current associated with CCM operation (e.g., Qv, as described above). In other words, the output current component associated with the ripple current can be combined with the output current component associated with the valley current (i.e., the minimum current during CCM operation), each of which can be derived from parameters of the control circuit without requiring external and/or direct measurement of the coil current. Thus, the average output current can be given by:

$${I}_{OUT \_ AVG} = \frac{1}{{T}_{m e a s}} {\int }_{{T}_{m e a s}} {I}_{coil} d t = \frac{{N}_{p u l s e s} \cdot Qp + Qv}{{T}_{m e a s}}$$

where Tₘₑₐₛ is the time window over which the average output current is calculated, Nₚᵤₗₛₑₛ is a count of PFM pulses during the Tₘₑₐₛ window, Qp is the charge delivered during each switching cycle, and Qv is the charge delivered by the valley current contribution.

With continued reference to FIG. 3, measurement window Tₘₑₐₛ is depicted as being between the vertical dashed lines. Nₚᵤₗₛₑₛ is the number of PFM pulses 314 over the interval, which can be counted and multiplied by Qp, determined, e.g., by calibration. It should be noted that Qp is constant when in DCM operation and is also a good approximation of the ripple contribution during CCM operation. Valley current contribution Qv can be measured by using the controller's current demand signal Idem, as described in greater detail below. Finally, FIG. 3 also the valley current signal to the analog to digital converter (further described below), and curve 316 illustrates samples 316 at a sampling interval Tsa, corresponding to a low pass filtered version of the valley current signal.

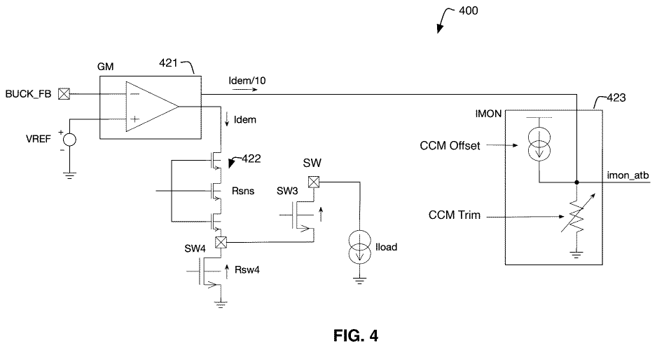

FIG. 4 illustrates a simplified schematic diagram 400 of a low power telemetry system for buck converters. Schematic diagram 400 depicts a portion of the buck converter control circuitry (such as control/driver circuitry 101 or 201) for deriving a representation of the valley current signal used to derive valley current contribution Qv, described above. In the illustrated example, the buck converter output voltage feedback signal BUCK_FB (corresponding to buck converter output voltage V out) is provided to an error amplifier 421. This feedback signal can be subtracted from a reference voltage VREF corresponding to the desired output voltage of the buck converter. The difference between these signals can be multiplied by a gain (transconductance) GM to produce a current demand signal Idem. Thus, the demanded current will increase when the output voltage falls below the reference voltage and will decrease when the output voltage rises above the reference voltage. The current demand signal can then be supplied to a duty cycle controller (not shown) to generate the drive signals for the high side switch(es) and low side switch(es) SW3, SW4 of the buck converter. The illustrated arrangement corresponds to a three-level buck converter, having two low side switches, but the same principles would apply to a conventional buck converter or any other buck converter type.

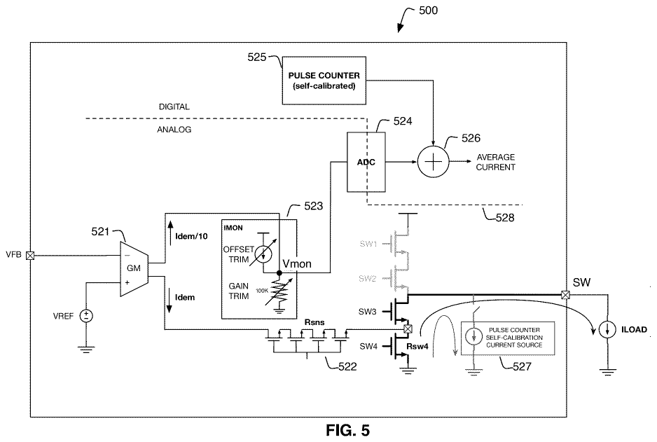

The current demand signal Idem can also be supplied via a sensing resistor Rsns to the junction of the low side switches SW4 and SW3. As noted above, the load current/inductor current/coil current can be drawn from the switch node SW, connected to the drain of switch SW3. (See also, FIGS. 1 & 2, above.) The current demand signal Idem or a scaled version of the current demand signal, eg., Idem/10 can also be supplied to a trim circuit 423 and eventually to an analog-to-digital converter as described in greater detail with reference to FIG. 5, below. In the illustrated example, trim circuit 423 includes an adjustable current source CCM offset that can be used to set the zero point of the current reference signal imon_atb supplied to the analog-to-digital converter. Trim circuit 423 can also include an adjustable CCM Trim resistor that can be used to scale the range of the valley current reference signal imon_atb supplied to the analog-to-digital converter. Further operation of the circuit can be understood with reference to FIG. 5.

FIG. 5 illustrates a simplified schematic diagram 500 of a low power telemetry system for buck converters, including the components described with reference to FIG. 4. As described above, the buck converter output voltage feedback signal VFB can be supplied to an error amplifier 521 that compares it to an output voltage reference. The output of error amplifier 521 can be a current demand signal Idem. The current demand signal can be supplied to duty cycle control circuitry (not shown) that generates the drive signals for the buck converter switches. FIG. 5 illustrates the switching ladder SW1-SW4 of a three-level buck converter, but the same principle applies to other buck converter types. As described above, the current demand signal can also be supplied via a sensing resistor 522 (Rsns) to the junction of switches SW3/SW4. The current demand signal or a scaled version thereof (e.g., Idem/10) can be provided to trim circuit 523, which can operate as described above with respect to trim circuit 423. Namely, trim circuit 523 can include an offset trim current source that can set the zero point of a voltage signal V mon provided to analog to digital converter 524 and a gain trim variable resistance that can set the full scale range of the voltage signal V mon. Trim circuit 523 thus acts to convert the scaled current demand signal to a voltage corresponding to the demand current signal.

Analog to digital converter 524 can receive the voltage signal V mon corresponding to the current demand signal (or scaled current demand signal) and produce a digital value corresponding to the valley current contribution to the total coil current. A pulse counter 525 can also count the PFM pulses (corresponding to the number of switching cycles of the power switches) during the measurement interval, which can be multiplied by the charge or energy transfer associated with each pulse to derive the ripple current contribution to the total current. The valley current contribution to the coil current and the ripple current contribution to the total current can then be added (block 526) to derive an average current value that can be used for any desired monitoring and/or control of the buck converter and/or associated circuitry.

Pulse counter 525 can be calibrated using pulse counter self-calibration current source 527 connected to the switch node SW of the buck converter. Selective operation of this self-calibration current source can be used to determine the ripple current contribution Qp, generally corresponding to the area under the curve of each current pulse 312/313 described and depicted above with reference to FIG. 3. It can also be appreciated that components below line 528 can be implemented in the analog domain, for example using analog circuitry, as described above, while components above line 528 can be implemented in the digital domain, using digital and/or programmable circuitry, as described above. Analog to digital converter 524 effectively straddles this divide between the analog and digital domains. Notwithstanding the foregoing, there could be implementations in which certain functions or operations depicted in the analog domain could be performed in the digital domain and/or vice-versa.

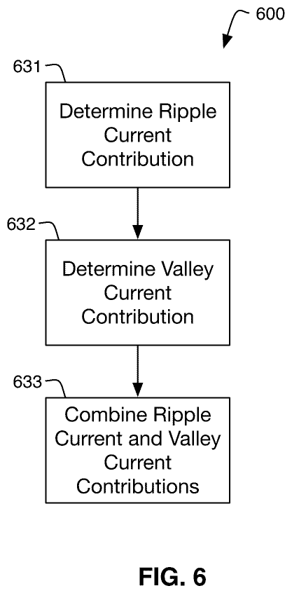

FIG. 6 illustrates a simplified flow chart 600 of an output current determination technique for a buck converter as described herein. In block 631, the control circuitry can determine a ripple current contribution to the output current, i.e, Qr as described above. In block 632, the control circuitry can determine a valley current contribution to the output current, i.e., Qv as described above. In block 633, the ripple current and valley current contributions can be combined (eg., using an equation of the form described above) to determine the total output current. As described above the ripple current contribution can be determined in part by counting switching cycles of the buck converter switches corresponding to PFM pulses generated by the control circuitry responsive to an output voltage feedback signal. This count of pulses can be multiplied by a per-pulse contribution to the output current. The valley current contribution can be determined by reference to the current demand signal of the control loop. This current demand signal can be scaled and offset as required. Various operations can be performed in the analog or digital domain as appropriate. By using signals already existing in the buck converter control circuitry, additional current measuring circuitry and components that would increase cost, complexity, and power consumption can be eliminated thereby reducing cost and improving operating efficiency.

The foregoing describes exemplary embodiments of low power telemetry systems for use in buck converters. Such configurations may be used in a variety of applications but may be particularly advantageous when used in conjunction power supplies for personal electronic devices, computing devices, etc. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A buck converter comprising:
an input that receives a DC input voltage;
a plurality of switching devices coupled across the input and switched complementarily, the plurality of switching devices having a switch node associated therewith;
an inductor having a first terminal coupled to the switch node associated with the plurality of switching devices and a second terminal coupled to an output of the buck converter that delivers a DC output voltage that is less than the DC input voltage; and
control circuitry that:
generates drive signals for the plurality of switching devices to regulate the output voltage; and
determines an output current of the buck converter by determining a ripple current contribution to the output current, determining a valley current contribution to the output current, and combining the ripple current contribution with the valley current contribution.

2. The buck converter of claim 1 wherein:
the buck converter is a three-level buck converter;
the plurality of switching devices include a switch ladder of four switching devices including an outer pair switched complementarily to each other and an inner pair switched complementarily to each other and 180 degrees out of phase with respect to the outer pair; and
the buck converter further comprises a flying capacitor coupled across the inner switch pair.

3. The buck converter of claim 2 wherein the control circuitry determines the ripple current contribution at least in part by using a pulse counter to count pulse frequency modulation pulses corresponding to switching cycles of the plurality of switching devices.

4. The buck converter of claim 2 wherein the control circuitry determines the valley current contribution with reference to a current demand signal determined by comparing an output voltage feedback signal of the buck converter to a reference voltage.

5. The buck converter of claim 4 wherein the current demand signal is a scaled current demand signal.

6. The buck converter of claim 4 wherein the current demand signal is trimmed to provide a desired offset and scale, wherein the offset is provided by an adjustable current source, and the scale is provided by a variable resistor.

7. The buck converter of claim 1 wherein the control circuitry determines the ripple current contribution at least in part by using a pulse counter to count pulse frequency modulation pulses corresponding to switching cycles of the plurality of switching devices.

8. The buck converter of claim 1 wherein the control circuitry determines the valley current contribution with reference to a current demand signal determined by comparing an output voltage feedback signal of the buck converter to a reference voltage.

9. The buck converter of claim 8 wherein the current demand signal is a scaled current demand signal.

10. The buck converter of claim 8 wherein the current demand signal is trimmed to provide a desired offset and scale, wherein the offset is provided by an adjustable current source and the scale is provided by a variable resistor.

11. A buck converter control circuit comprising:
duty cycle control circuitry that generates drive signals for a plurality of switching devices of the buck converter to regulate an output voltage of the buck converter by comparing an output voltage of the buck converter to a reference voltage; and
output current determination circuitry that determines an output current of the buck converter by:
determining a ripple current contribution to the output current;
determining a valley current contribution to the output current;
and combining the ripple current contribution with the valley current contribution.

12. The buck converter control circuit of claim 11 wherein the control circuit determines the ripple current contribution at least in part by using a pulse counter to count pulse frequency modulation pulses corresponding to switching cycles of the plurality of switching devices.

13. The buck converter control circuit of claim 11 wherein the control circuitry determines the valley current contribution with reference to a current demand signal determined by comparing an output voltage feedback signal of the buck converter to a reference voltage.

14. The buck converter control circuit of claim 13 wherein the current demand signal is a scaled current demand signal.

15. The buck converter control circuit of claim 13 wherein the current demand signal is trimmed to provide a desired offset and scale, wherein the offset is provided by an adjustable current source, and the scale is provided by a variable resistor.

16. A method of determining an output current of the buck converter, performed by control circuitry of a buck converter, the method comprising:
determining a ripple current contribution to the output current;
determining a valley current contribution to the output current; and
combining the ripple current contribution with the valley current contribution.

17. The method of claim 16 wherein determining the ripple current contribution includes using a pulse counter to count pulse frequency modulation pulses corresponding to switching cycles of a plurality of switching devices of the buck converter.

18. The method of claim 16 wherein determining the valley current contribution includes reference to a current demand signal determined by comparing an output voltage feedback signal of the buck converter to a reference voltage.

19. The method of claim 18 wherein the current demand signal is a scaled current demand signal.

20. The method of claim 18 wherein the current demand signal is trimmed to provide a desired offset and scale, wherein the offset is provided by an adjustable current source, and the scale is provided by a variable resistor.
